(19) United States
(12) Patent Application Publication
(10) Pub. No.: US 2011/0115132 A1
(43) Pub. Date: May 19, 2011

(54) MOLD ASSEMBLY AND ATTENUATED LIGHT PROCESS FOR FABRICATING MOLDED PARTS

(75) Inventors: Matthew Peter Burdzy, South Windsor, CT (US); Robert P. Cross, Rocky Hill, CT (US)

(73) Assignee: Henkel Corporation, Rocky Hill, CT (US)

(21) Appl. No.: 13/012,444

(22) Filed: Jan. 24, 2011

Related U.S. Application Data
(63) Continuation of application No. PCT/US09/51532, filed on Jul. 23, 2009.
(60) Provisional application No. 61/083,778, filed on Jul. 25, 2008.

(51) Int. Cl. B29C 45/72; B29C 35/08; B29C 39/02; B29C 39/38

(52) U.S. Cl. 264/478; 425/174.4

(57) ABSTRACT

The present invention relates to a mold-in-place gasket forming assembly that includes a flange, a mold and an electromagnetic radiation filter for improved cycling. The present invention further relates to a mold-in-place gasketing process.

This application is a continuation of International Application PCT/US2009/051532, filed on Jul. 23, 2009, which claims benefit of U.S. Provisional Application No. 61/083,778, filed on Jul. 25, 2008, the contents of each of which is incorporated herein by reference in its entirety.

### BACKGROUND OF THE INVENTION

1. Field of the Invention

The present invention relates to a mold-in-place gasket forming assembly that includes a flange, a mold and an electromagnetic radiation filter for improved cycling. The present invention further relates to a mold-in-place gasketing process using the mold-in-place gasket forming assembly.

2. Brief Description of Related Technology

Mold-in-place gaskets have been formed by liquid injection of a gasket-forming material into a mold. Typical processes include the use of high temperature and/or high pressure liquid injection. For example, a typical process is described in U.S. Pat. No. 5,597,523 to Sakai et al. The molding process and molding device requires use of both an elevated pressure, typically about 24,500 kPa (3,500 psig) and an elevated temperature, e.g. 250° C. (480° F.). In some instances, upper and lower molds are mated to one another to define a mold cavity therebetween. In some instances, a flat cover or flange is mated to a mold to define a mold cavity therebetween. Gasket forming material, such as an epoxy resin or plastic rubber, is pumped into a mold cavity at 2,900 kPa (430 psig). The molds and the gasket material are heated to about 250° C. (480° F.). The gasket forming material in pumped into the mold cavity. The molds are then clamped together at the elevated pressure e.g. 24,500 kPa (3,500 psig). After the gasket material is cured, by a form of electromagnetic radiation or other cure technique, the molds and the gasket are cooled to room temperature. The use of such elevated pressures and temperatures at such short cycle times, however, require the use of metallic molds that can withstand such large fluctuations in pressure and temperature while maintaining close tolerances to form the gasket, which make the apparatus and the process expensive and difficult to operate.

Useful mold-in-place gaskets most desirably have a high modulus, sealing force and tensile strength, while maintaining an acceptable compressibility. Generally, techniques to improve the modulus, sealing force and/or tensile strength have resulted in an undesirable lowering of the compressibility or other physical properties.

Current mold-in-place gasketing assemblies use polymeric molds due to their low cost, toughness and commercial availability. However, polymeric molds suffer from numerous disadvantages, such as undergoing cold flow and degradation after exposure to UV light. The degradation of these molds may cause undesirable separation from the gasket during the molding process. Mold deterioration during use due to the UV light exposure is problematic and results in a very limited number of cycles of use before the mold can no longer produce acceptable gaskets.

There is currently a need for a mold-in-place gasket forming assembly that provides an increase in the number of successful cycles attained before experiencing a failure, i.e. a deterioration of the mold. Further, there is a need for such gaskets that are able to maintain an effective sealing force at lower temperatures. There is also a need for a mold-in-place gasketing process that provides an increase in successful cycles before experiencing a deterioration of the mold.

### SUMMARY OF THE INVENTION

The present invention provides a mold-in-place gasket assembly and gasket-forming process that permits a greatly improved mold cyclization. For example, in some instances more than 2000 cycles of use can be achieved with the present invention.

In one aspect of the invention, there is provided a mold-in-place gasket-forming assembly, which includes: a flange having an area for receiving flowable gasket-forming material; a mold transparent to electromagnetic radiation and having inner and outer surfaces, the inner surface defining a mold cavity, the mold being sealed about the area to receive gasket-forming material directed therein; an electromagnetic radiation filter positioned between a source of electromagnetic radiation and the mold cavity, where the electromagnetic radiation filter is proximal to the outer surface of the mold to filter and/or attenuate wavelengths of light below 10,000 nm; and a gasket-forming material including an electromagnetic radiation curable composition.

In another aspect of the invention, a mold-in-place gasket-forming assembly, which includes: an application flange having a recessed area for receiving injected gasket-forming material; a silicone mold transparent to ultraviolet light and having inner and outer surfaces, the inner surface defining a mold cavity, the silicone mold being sealed about the area to receive gasket-forming material directed therein; an ultraviolet light filter positioned between a source of ultraviolet light and the mold cavity, where the ultraviolet light filter is proximal to the outer surface of the silicone mold to filter out wavelengths of light lower than 400 nm; and a gasket-forming material including ultraviolet light curable polyacrylate.

In another aspect of the invention, a mold-in-place gasketing process is provided for producing a gasket, which includes the steps of: providing a mold assembly that includes a flange having an area for receiving a flowable gasket-forming material, a mold transparent to electromagnetic radiation and having inner and outer surfaces, the inner surface defining a mold cavity, the mold being sealed about the area to receive gasket-forming material directed therein and an electromagnetic radiation filter positioned proximal to the outer surface of the mold to filter or attenuate wavelengths of light below 10,000 nm; injecting a gasket-forming material that includes an electromagnetic radiation curable composition into the mold of the mold assembly; directing electromagnetic radiation through the filter and mold to cure the material and form a gasket; and separating the gasket from the mold without visually detectable cohesive failure of the gasket or the mold.

### BRIEF DESCRIPTION OF THE DRAWINGS

FIG. 1 is a perspective view of each of the components of the mold-in-place gasket-forming assembly of the present invention and their position in the assembly.

FIG. 2 is representation of the mold and flange of the present invention showing a top view of a flange having a gasket molded-in-place on its surface and a bottom view of a mold designed to mate with the flange and allow formation of the gasket.

FIG. 3 is a perspective cutaway view of an embodiment of the present invention.

FIG. 4 is a flow diagram representing the mold-in-place gasketing process of the present invention.

### DETAILED DESCRIPTION OF THE INVENTION

The gasket assemblies of the present invention provide the ability to be used for a large number of cycles as compared to the prior art. For example, in certain embodiments, the assembly can be used over a 1000 times more than the prior art to produce acceptable gaskets. The term “acceptable gasket” is intended to mean that the gasket is free of obvious defects and can be separated from the mold after it is formed without visually observable defects. Typically the gasket assemblies of the prior art had comparatively low cycle life due to the breakdown in the mold, which in many cases results in the mold and/or gasket having observable defects. Such defects include portions of the mold remaining on the gasket after separation and vice versa.

The present invention provides an assembly and process for forming a mold-in-place gasket that includes a flange, a mold transparent to electromagnetic radiation and an electromagnetic radiation filter in combination with a composition that forms the gasket. This combination allows for a mold-in-place assembly and process that permits high cyclization values and allows molds to be used many more times than those currently used in the art. The filter, flange, mold and gasket-forming material together greatly increase the ability to achieve these results.

The mold-in-place gasket-forming assembly of the present invention may be used with various mold-in-place gasket forming molds that may be formed directly on a flange. Any form or arrangement of a mold may be used, provided that the mold is transparent to electromagnetic radiation. Traditional molds include an upper mold member and a lower mold member, designed to fit in communication with each other and forming a mold cavity, and an injection port in fluid communication with the mold cavity. The inner surface of the transparent to electromagnetic radiation mold may define a mold cavity and be sealed around the area of the flange that is suitable for receiving a gasket-forming material. The cavity may be any shape or size desired. The gasket-forming material may be introduced into the area for receiving the gasket-forming material via an injection port. Once injected, the material may be exposed to electromagnetic radiation. In this aspect, a source of electromagnetic radiation is provided, which is transmitted through the mold cavity to the gasket-forming material. An electromagnetic radiation filter may be positioned between the source of radiation and the mold cavity, proximal to the outer surface of the mold.

Useful electromagnetic radiation in connection with the present invention includes ultraviolet light, visible light, infrared light and combinations thereof. As used herein, “electromagnetic radiation” means any radiation having a wavelength of from about 200 nm to about 10,000 nm and desirably about 200 nm to about 1,000 nm, which is capable, directly or indirectly, of curing the specified resin component of the resin composition. By indirect curing in this context is meant curing under such electromagnetic radiation conditions, as initiated, promoted, or otherwise mediated by another compound. Useful ultraviolet light (UV) includes, but is not limited to, UVA (about 320 nm to about 410 nm), UVB (about 290 nm to about 320 nm), UVC (about 220 nm to about 290 nm) and combinations thereof. Useful visible light includes, but is not limited to, blue light, green light, red light, and combinations thereof. Such useful visible lights have a wavelength from about 450 nm to about 750 nm. Useful infrared light includes, but is not limited to, near infrared (NIR), short-wavelength infrared (SWIR), mid-wavelength infrared (MWIR), long-wavelength infrared (LWIR), and far infrared (FIR). Such useful infrared lights have a wavelength of from about 750 nm to about 10,000 nm.

A filter may be used to restrict the amount of radiation to which the gasket forming material is exposed. The filter may modify the output of the light source by attenuation of wavelengths of light that may be detrimental to the gasket forming material. The filter may be selected based on the source of radiation, mold and gasket forming material. The combination of filter and source control the amount of radiation that is exposed to the gasket forming material. In addition, the mold may also function as a filter by attenuating light exposed to the gasket forming material.

Examples of useful filters may include optic filters. Optic filters may include filters that focus on light attenuation properties, such as bandpass, shortpass, longpass, narrowband, wideband, rejection band, absorption band, UV, color substrate, color additive and any combinations thereof. Optical filters may include, glass filters, coated glass filters, laminated glass filters, plastic filters, coated plastic filters, laminated plastic filters and combinations thereof. Optical filters may be absorptive filters, reflective filters, refractive filters, diffractive filters or a combination thereof.

Useful electromagnetic radiation filters in connection with the present invention may include standard and optical longpass and UV filters, such as those made by Omega Optical, Inc. Useful thin film filters, such as those made by Optical Filters Ltd, also may be used. Bandpass and dichrotic filters, such as those made by Newport Corporation, also may be used. Filters useful for microscopy, bandpass filters, multiple bandpass filters, longpass filters and longpass dichroic mirror filters, such as those made by Chroma Technology Group, may be used. Filters made by Andover Corporation, such as bandpass filters, neutral density filters, longpass filters, shortpass filters and heat-control filters may be used. Optical filters for diodes, such as those made by Intor, Inc. may be used. Filters for use in the photonics industry, such as those by Sterling Precision Optics, may be used. Absorbing glass optical filter, such as those by Ocean Optics Worldwide Headquarters, may be used. In addition, any filter by Midwest Optical Systems, Inc., such as color bandpass filters, protective/UV block filters and longpass/color filters, may be used. Window filters, such as those made by Custom Scientific, Inc., may be used. Any type of filter by BES Optics, Inc. may be used. Spectro Film's diode filters may be useful in connection with the present invention. Longpass filters, such as those made by UGQ (Optics) Ltd. may be used. Glass laminates with UV filtering, such as those made by DuPont, Saflex or Viracon, Inc., may be useful with the present invention.

Optical coatings for filters, such as those by Princeton Instruments, Inc., may be used.

The radiation generated from a source is transmittable to the area for receiving gasket-forming material and mold cavity when the mold and flange are disposed in a substantial abutting relationship. The means for transmitting electromagnetic radiation to the area for receiving gasket-forming material and mold cavity may include the use of an electromagnetic radiation source, whereby the electromagnetic radiation may be transmitted directly through the mold. The electromagnetic radiation source may transmit radiation throughout the entire mold, or a portion of the mold. Further, the electromagnetic radiation source may be one or more channels in the mold member(s) through which the electromagnetic radiation may travel to the area for receiving gasket-forming material. The electromagnetic radiation source or a portion of the source may be made from a transmissible thermoplastic material, such as polycarbonate acrylate, silicone, polyisobutylene or other transmissible polymeric members, and/or may include pathways, such as conduits or fiber optic cables, through which the electromagnetic radiation is transmissible or passable.

In another aspect of the present, one of the members forming the gasket-shaped cavity (i.e. the area for receiving gasket-forming material) may be itself an article of manufacture or a part of an article of manufacture, such as an portion of a vehicle, for example a valve cover. The compositions of the present invention may be formed directly on such an article of manufacture or a part thereof by the methods of the present invention. Thus, upon curing the gasket-forming material of the present invention and removing the electromagnetic radiation-conducting-mold, which is transparent to the electromagnetic radiation, the article or part is produced with an integral gasket. This eliminates the need for mechanically and/or chemically attaching a separately formed gasket to the article or part.

The present invention includes an electromagnetic radiation curable composition, useful for forming mold-in-place gaskets. The mold-in-place gaskets of the present invention exhibit improved tensile modulus and sealing force under compression, while maintaining a sufficient compression level.

A wide range of electromagnetic radiation curable compositions may be used to form the gaskets. Useful, non-limiting compositions include electromagnetic radiation curable siloxanes, polyacrylates, polyurethanes, polyethers, polyolefins, polyesters, copolymers thereof and combinations thereof.

More desirably, the gasket-forming material may include at least one monomer. A wide variety of monomers may be used. Desirably, the monomers used in the present invention are (meth)acrylate monomers. Such monomers are desirably characterized as being either flexible or rigid. It will be apparent to one of ordinary skill in the art that the choice of monomers is dependent on the desired properties of the resultant sealant product. Within the (meth)acrylate component are a wide variety of materials represented by H₂C═CGCO₂R, where G may be hydrogen, halogen or alkyl of 1 to about 4 carbon atoms, and R may be selected from alkyl, cycloalkyl, alkenyl, cycloalkenyl, alkaryl, aralkyl or aryl groups of 1 to about 16 carbon atoms, any of which may be optionally substituted or interrupted as the case may be with silane, silicon, oxygen, halogen, carbonyl, hydroxyl, ester, carboxylic acid, urea, urethane, carbamate, amine, amide, sulfur, sulfonate, sulfone and the like.

More specific (meth)acrylate monomers particularly desirable for use herein include polyethylene glycol di(meth)acrylates, desirably triethyleneglycol di(meth)acrylate, hydroxypropyl (meth)acrylate, bisphenol-A di(meth)acrylates, such as ethoxylated bisphenol-A (meth)acrylate (“EBIPA” OR “EBIPMA”), and tetrahydrofuran (meth)acrylates and di(meth)acrylates, citronellyl acrylate and citronellyl methacrylate, hexanediol di(meth)acrylate (“HDDA” or “HDDMA”), trimethylol propane tri(meth)acrylate, tetrahydrodicyclopentadienyl (meth)acrylate, ethoxylated trimethylol propane triacrylate (“ETTA”), triethylene glycol diacrylate and triethylene glycol dimethacrylate (“TRIEGMA”).

For purposes of illustration only, listed herein are examples of urethane-acrylate monomers suitable for use in the gasket-forming compositions of the present invention. However, it is to be understood that any acrylate resin, including non-urethane acrylates and methacrylates may be used in the present invention. Desirably, monomers used in the present invention are polyurethane polyacrylate monomers. Examples of such monomers are described in U.S. Pat. No. 3,425,988 to Gorman et al., specifically incorporated by reference herein. These monomers may be represented by the following general formula:

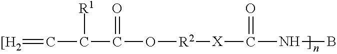

where B may be a polyvalent organic radical selected from the group consisting of alkyl, alkenyl, cycloalkyl, aryl, aralkyl, alkaryl and heterocyclic radicals both substituted and unsubstituted; X may be selected from the group consisting of —O— and

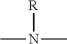

radicals; n may be an integer from 2 to 6 inclusive; R¹ may be a member selected from the class consisting of hydrogen, chlorine and methyl and ethyl radicals; and R² may be a divalent organic radical selected from the group consisting of lower alkylene of 1 to 8 carbon atoms, phenylene and naphthalene radicals.

Additional urethane-acrylate-capped poly(alkylene) ether polyol monomers, such as those described in U.S. Pat. No. 4,018,851 to Baccei, specifically incorporated by reference herein, may be used in the gasket forming compositions of the present invention. Further, urethane-acrylate-capped polybutadiene-based monomers, such as those described in U.S. Pat. No. 4,295,909, to Baccei, specifically incorporated by reference herein, may be used in the present invention.

Additional anaerobic curing monomers useful in the present invention include the alkylene glycol diacrylates having the general formula:

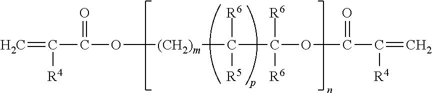

where R⁶ represents a radical selected from the group consisting of hydrogen, lower alkyl of 1- 4 carbon atoms, inclusive, hydroxyalkyl of 1-4 carbon atoms inclusive, and

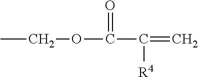

where R⁴ may be a radical selected from the group consisting of hydrogen, halogen, and lower alkyl of 1-4 carbon atoms; R⁵ may be a radical selected from the group consisting of hydrogen, —OH and

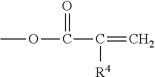

where m may be an integer equal to at least 1, desirably 1-8 and more desirably from 1 to 4; n may be an integer equal to at least 1, desirably 1 to 20; and p may be 0 or 1.

Additional anaerobic curing monomers useful in the gasket-forming compositions of the present invention include mono-, di-, tri- tetra- and polyethylene glycol dimethacrylate and the corresponding diacrylates; di(pentamethylene glycol) dimethacrylate; tetraethylene glycol di(chloroacrylate); diglycerol diacrylate; diglycerol tetramethacrylate; butylene glycol dimethacrylate; neopentyl glycol diacrylate; and trimethylopropane triacrylate.

Useful polymerizable crosslinkable components useful in the gasket forming compositions of the present invention are ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate and combinations thereof. Other useful monomers include those acrylates derived from bisphenol-A, such as bisphenol-A dimethacrylate, hydrogenated bisphenol-A dimethacrylate, and ethoxylated bisphenol-A di(meth)acrylate.

Desirably, the gasket-forming compositions may include a polyacrylate. Useful polyacrylates, include 1,3-butylene glycol diacrylate, diethylene glycol diacrylate, 1,6-hexanediol diacrylate, neopentylglycol diacrylate, polyethylene glycol diacrylate, tetraethylene glycol diacrylate, methylene glycol diacrylate, pentaerythritol tetraacrylate, tripropylene glycol diacrylate, ethoxylated bisphenol-A-diacrylate, trimethylolpropane triacrylate, di-trimethylolopropane tetraacrylate, dipenterythritol pentaacrylate, pentaerythritol triacrylate and the corresponding methacrylate compounds. Most desirably, the gasket-forming material includes an acrylate terminated telechelic polyacrylate. Also useful are reaction products of (meth)acrylic acid and epoxide resins, and urethane resins. Suitable poly(meth)acrylic ester compounds are also described in U.S. Pat. Nos. 4,051,195, 2,895,950, 3,218,305, and 3,425,988

While di- and other polyacrylate esters have been found particularly desirable, monofunctional acrylate esters (esters containing one acrylate group) also may be used. When dealing with monofunctional acrylate esters, it may be desirable to use an ester which has a relatively polar alcoholic moiety. Such materials are less volatile than low molecular weight alkyl esters and, more importantly, the polar group tends to provide intermolecular attraction during and after cure, thus producing more desirable cure properties, as well as a more durable sealant or adhesive. Particularly desirable are the polar groups selected from labile hydrogen, heterocyclic ring, hydroxy, amino, cyano, and halogen polar groups. Useful examples of compounds within this category include cyclohexyl methacrylate, tetrahydrofurfuryl methacrylate, hydroxyethyl acrylate, hydroxypropyl methacrylate, t-butylaminoethyl methacrylate, cyanoethylacrylate, and chloroethyl methacrylate. These materials are often incorporated as reactive diluents which are capable of copolymerizing with various other polymerizable materials present.

The monomers used in the gasket forming compositions of the present invention may desirably have a molecular weight from about 1,000 to about 100,000, more desirably from about 3,000 to about 40,000. Desirably, the monomer has a viscosity of about 10 Pas (10,000 cPs) to about 120 Pas (120,000 cPs). Additionally, the monomer desirably has a specific gravity of from about 1.0 to about 1.30 Particularly desirable materials are commercially available from Kaneka Corporation, Japan, such as under the trade designations RC220C, RC210C, RC200C, RC100C and XX0013C. It is believed that the RC220C, RC210C, RC200C and XX00113C are each terpolymers of combinations of substituted and unsubstituted alkylacrylates, such as ethyl acrylate, 2-methoxyethyl acrylate and n-butyl acrylate (varying by molecular weight), whereas the RC100C is a homopolymer of n-butyl acrylate.

The gasket-forming material of the present invention may include an active fumed silica. It has been found that the use of active fumed silica improves the physical characteristics of the gasket once formed. These improvements are more fully demonstrated in the Examples below. As used herein, “active” fumed silica refers to fumed silica that has been rendered chemically active and desirably functions as a solid crosslinker. Desirably, the active fumed silica may be an acrylated treated fumed silica. Most desirably, the active fumed silica may be a methacrylsilane treated silica, which functions as a crosslinker. Useful active fumed silicas include 2-propenoic acid, 2-methyl-,3-(trimethoxysilyl) propylester, reaction products with silica. Suitable active fumed silicas are commercially available from, for example, Evonik Industries, and sold under the trade name Aerosil. Such active fumed silicas include those under the trade designation R7200, which is a structure modified and methacrylsilane after-treated fumed silica.

Other fillers, including fumed silica fillers, such as conventional (i.e., non-activated) hydrophobic fumed silica may additionally be included in the gasket-forming material. Such fumed silicas may be treated with materials such as hexamethyldisilazane, trimethoxyoctylsilane and polydimethylsiloxane, which provides additional hydrophobicity but little to no reactive functionality. For example, traditional hydrophobic fumed silica, such as that commercially available from Evonik Industries and sold under the trade name Aerosil, or such as those available commercially from Cabot Corporation under the tradename CABOSIL or from Wacker under the tradename HDK-2000.

The gasket-forming material may further include a plasticizer. It has been found that the use of plasticizers in the gasket-forming material improves the physical characteristics of the formed gasket. Plasticizers have been found to not only increase the elongation of the product, but further have the effect of depressing the glass transition temperature (Tg) of the product. Having a lower Tg results in the product having a higher amount of sealing force at lower temperatures. With the inclusion of the plasticizer, the product has a sufficient sealing force at temperatures as low as about −20° C. to about −30° C. In addition, plasticizers have been found to lower the extractability in the anticipated service media and have a low impact on modulus. The improved characteristics are more fully demonstrated in the Examples set forth below.

Suitable plasticizers include those plasticizers commonly known in the art, including but not limited to monomeric and dimeric plasticizers. One desirable plasticizer is di(butoxyethoxyethoxyethyl) glutarate, which is commercially available from HallStar under the trade name Plasthall DBEEEG. Other traditional plasticizers are suitable for the gasket-forming material described herein.

Desirably, the gasket-forming material includes a photoinitiator. A number of photoinitiators may be employed herein to provide the benefits and advantages of the present invention to which reference is made above. Photoinitiators enhance the rapidity of the curing process when the photocurable compositions as a whole are exposed to electromagnetic radiation, such as actinic radiation. Desirably, the photoinitiator may be a non-peroxide photoinitiator, and most desirably may be a blend of propanone and phosphine oxide, however other photoinitiators may suitably be used. A photoinitiator may be added to the composition in an amount effective to respond to the electromagnetic radiation and to initiate and induce curing of the associated components, via substantial polymerization thereof.

Suitable photoinitiators useful with ultraviolet (UV) electromagnetic radiation curing mono- and polyolefinic monomers include free radical generating UV initiators such as substituted benzophenones and substituted acetophenones, benzoin and its alkyl esters and xanthone and substituted xanthones. Preferred photoinitiators include diethoxy-acetophenone, benzoin methyl ether, benzoin ethyl ether, benzoin isopropyl ether, diethoxyxanthone, chloro-thio-xanthone, azo-bisisobutyronitrile, N-methyl diethanol-amine-benzophenone and mixtures thereof. Particular examples of suitable photoinitiators for use herein include, but are not limited to, photoinitiators available commercially from Ciba Specialty Chemicals, under the “IRGACURE” and “DAROCUR” trade names, specifically IRGACURE 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4,4-trimethyl pentyl) phosphine oxide and 2-hydroxy-2-methyl-1-phenyl-propan-1-one), 819 [bis(2,4,6-trimethyl benzoyl) phenyl phosphine oxide], 2022 [IRGACURE 819 dissolved in DAROCUR 1173 (described below)] and DAROCUR 1173 (2-hydroxy-2-methyl-1-phenyl-1-propan-1-one) and 4265 (the combination of 2,4,6-trimethylbenzoyldiphenyl-phosphine oxide and 2-hydroxy-2-methyl-1-phenyl-propan-1-one); and the visible light [blue] photoinitiators, dl-camphorquinone and IRGACURE 784DC. Of course, combinations of these materials may also be employed herein.

Other photoinitiators useful herein include alkyl pyruvates, such as methyl, ethyl, propyl, and butyl pyruvates, and aryl pyruvates, such as phenyl, benzyl, and appropriately substituted derivatives thereof. Photoinitiators particularly well-suited for use herein include ultraviolet photoinitiators, such as 2,2-dimethoxy-2-phenyl acetophenone (e.g., IRGACURE 651), and 2-hydroxy-2-methyl-1-phenyl-1-propane (e.g., DAROCUR 1173), bis(2,4,6-trimethyl benzoyl) phenyl phosphine oxide (e.g., IRGACURE 819 and IRGACURE 2022), and the ultraviolet/visible photoinitiator combination of bis(2,6-dimethoxybenzoyl-2,4,4-trimethylpentyl) phosphine oxide and 2-hydroxy-2-methyl-1-phenyl-propan-1-one (e.g., IRGACURE 1700), as well as the visible photoinitiator bis (η⁵-2,4-cyclopentadien-1-yl)-bis[2,6-difluoro-3-(1H-pyrrol-1-yl)phenyl]titanium (e.g., IRGACURE 784DC).

In addition to the above-described composition, the composition may further include a (meth)acryloyl-terminated compound having at least two (meth)acryloyl pendant groups selected from (meth)acryloyl-terminated polyethers, meth)acryloyl-terminated polyolefins, (meth)acryloyl-terminated polyurethanes, (meth)acryloyl-terminated polyesters, (meth)acryloyl-terminated silicones, copolymers thereof, and combinations thereof. Details of such (meth)acryloyl-terminated materials may be found in European Patent Application No. EP 1 059 308 A1 to Nakagawa et al., and may be commercially available from Kaneka Corporation, Japan.

The gasket forming compositions of the present invention may further include reactive diluents, rubber toughening agents, antioxidants and/or mold release agents.

As the reactive diluent, the composition may include a monofunctional (meth)acrylate. Useful monofunctional (meth)acrylates may be embraced by the general structure CH₂═C(R)COOR² where R is H, CH₃, C₂H₅ or halogen, such as Cl, and R² is C₁₋₈ mono- or bicycloalkyl, a 3 to 8-membered heterocyclic radial with a maximum of two oxygen atoms in the heterocycle, H, alkyl, hydroxyalkyl or aminoalkyl where the alkyl portion is C₁₋₈ straight or branched carbon atom chain. Among the specific monofunctional (meth)acrylate monomers particularly desirable, and which correspond to certain of the structures above, are hydroxypropyl methacrylate, 2-hydroxyethyl methacrylate, methyl methacrylate, tetrahydrofurfuryl methacrylate, cyclohexyl methacrylate, 2-aminopropyl methacrylate, isobornyl methacrylate, isodecyl methacrylate, 2-ethyl hexyl methacrylate and the corresponding acrylates.

In addition, N,N-dimethyl acrylamide (“DMAA”) acrylic acid, and β-carboxyethyl acrylate (such as is available commercially from Rhodia under the tradename SIPOMER) are usefully employed in the gasket-forming composition of the present invention.

Commercially available representative examples of such reactive diluents include those used in the samples below. More specifically, SARTOMER SR395 (isodecyl acrylate, commercially available from Sartomer Company, Inc., Exton, Pa.), SARTOMER SR495 (caprolactone acrylate, commercially available from Sartomer), SARTOMER SR531 (cyclic trimethylolpropane formal acrylate, commercially available from Sartomer), and SARTOMER PRO6622 (3,3,5 trimethylcyclohexyl acrylate, commercially available from Sartomer) are each appropriate choices, either alone or in combination with each other or with the other noted reactive diluents.

The gasket-forming compositions of the present invention may also include rubber toughening agents, such as those used in the samples below. More specifically, commercially available ones include VAMAC DP (an ethylene acrylic dipolymer elastomer available commercially from DuPont), HYCAR VTBN (methacrylate-functional acrylonitrile-butadiene-copolymers commercially available from Hanse Chemie), HYPALON 20 (commercially available from DuPont, and reported to be greater than 96% chlorosulfonated polyethylene, less than 0.4% carbon tetrachloride, less than 0.04% chloroform and less than 2% talc), NEOPRENE AD-10 (commercially available from DuPont, and reported to be greater than 98% 2chloro-1,3-butadiene polymers and copolymers, less than 1% water and less than 1% talc), NIPOL IR2200L (commercially available from Zeon, and reported to be greater than 99% polyisoprene polymer), RICACRYL 3100 (commercially available from Sartomer and reported to be a methacrylated polybutadiene low-functional UV-curable resin), and combinations thereof.

As an antioxidant, the gasket-forming compositions of the present invention may desirably include phenolic and/or phosphite antioxidants, including those available commercially from Ciba Specialty Chemicals under the tradename IRGANOX, representations of which are seen in the several examples in the samples below. Other traditional antioxidants are suitable in the present gasket-forming material.

As a mold release agent, the gasket-forming compositions of the present invention may include those available commercially for instance from Crompton Corporation under the tradename MOLD-PRO 678 (a powdered stearic acid).

Optionally, or alternatively, a mold release agent may be applied to the area for receiving the gasket-forming material prior to the introduction of the gasket-forming material. The release agent, if needed, helps in the easy removal of the cured gasket from the area. Useful mold release compositions include, but are not limited, to dry sprays such as polytetrafluoroethylene, and spray-on-oils or wipe-on-oils such as silicone or organic oils. Useful mold release compositions include, but are not to compositions including C₆ to C₁₄ perfluoroalkyl compounds terminally substituted on at least one end with an organic hydrophilic group, such as betaine, hydroxyl, carboxyl, ammonium salt groups and combinations thereof, which is chemically and/or physically reactive with a metal surface. A variety of mold releases are available, such as those marketed under Henkel's FREKOTE brand. Additionally, the release agent may be a thermoplastic film, which can be formed in the mold shape.

Desirably, the monomer(s), for example the polyacrylate, may be present in an amount of from about 40 percent to about 75 percent by weight of the composition, and most desirably from about 50 to about 70 percent by weight.

Desirably, the active fumed silica may be present in an amount of from about 5 percent to about 30 percent by weight of the gasket-forming compositions of the present invention, and most desirably may be present in an amount of at least 10 percent to about 20 percent by weight. Other fillers, such as hydrophobic fumed silica may be present in an amount from about 0.1 percent to about 10 percent, and most desirably from about 2 percent to about 5 percent by weight. Desirably, the traditional fumed silica may be present in an amount less than active fumed silica.

When used, the plasticizer used in the gasket-forming compositions of the present invention may be present in an amount of from about 5 percent to about 20 percent by weight of the composition, and most desirably may be present in an amount of from about 10 percent to about 15 percent by weight.

The photoinitiator used in the gasket-forming compositions of the present invention may be desirably present in an amount of from about 0.5 percent to about 5 percent by weight of the composition, and most desirably from about 1 percent to about 2 percent by weight.

When present, the reactive diluent used in the gasket-forming compositions of the present invention may be desirably used in the range of 0.5 to about 50 percent by weight, such as about 5 to about 30 percent by weight, and most desirably in the range of from about 10 percent to about 20 percent by weight.

When present, the rubber toughening agent used in the gasket-forming compositions of the present invention may be desirably used in the range of about 0.5 to about 30 percent by weight, such as about 2.5 to about 10 percent by weight.

When present, the antioxidant used in the gasket-forming compositions of the present invention may be desirably used in an amount of from about 0.1 percent to about 5 percent, and most desirably in an amount of from about 0.3 to about 1 percent by weight.

The formed gasket of the present invention desirably has an improved modulus and level of elongation, while maintaining a sufficient compressibility. Desirably, the formed gasket has a tensile modulus at 100% elongation of from about 300 psi to about 500 psi, and more specifically from about 400 psi to about 450 psi. Additionally, the formed gasket of the present invention desirably has an improved initial sealing force (measured with a Dyneon CSR fixture at 25% compression), desirably from about 80 N to about 100 N. While the physical characteristics of tensile modulus and initial sealing force are improved, the formed gasket of the present invention desirably maintains a low compression set. Most desirably, the formed gasket has a compression set (1000 Hr @ 150° C.) of below about 55%, and most desirably from about 45% to about 55%.

The present invention additionally provides a method of forming a gasket by liquid injection. In one aspect, the gasket-forming material includes an electromagnetic radiation curable composition, which includes a polyacrylate, an active fumed silica and a photoinitiator. As described above, other additional components, including a reactive diluent, toughening agent, antioxidant, plasticizer and mold release agent may be included. There is further provided an injection mold, such as those described above. The mold may include one or more than one separate pieces which may be placed in communication with each other to define an enclosed gasket-forming cavity. Further, the mold desirably includes at least one injection port communicating with the area for receiving the injection of the gasket-forming material. The injection mold further has a means for permitting electromagnetic radiation through to the cavity, as described above.

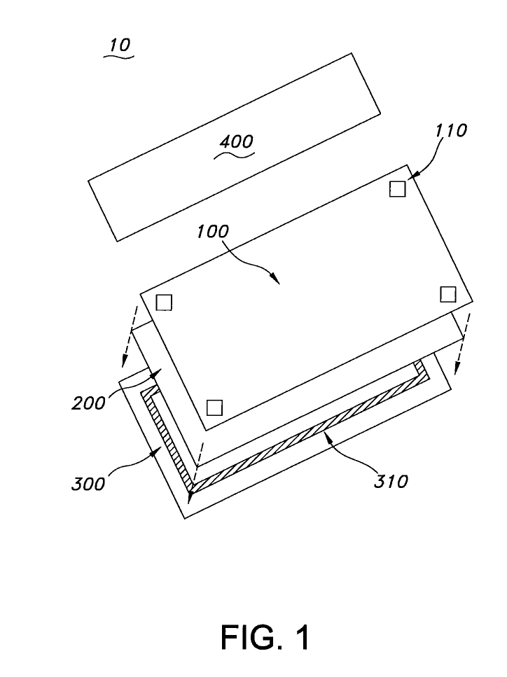

FIG. 1 represents a mold-in-place gasket-forming assembly 10 of the present invention that utilizes electromagnetic radiation, the wavelengths of which are filtered and/or attenuated by a filter to cure the gasket-forming product. The mold-in-place gasket-forming assembly 10 may include an electromagnetic radiation source 400, an electromagnetic radiation filter 100, an electromagnetic radiation transparent mold 200 and a flange 300 having an area for receiving gasket-forming material 310. The filter 110, mold 200 and the flange 310 may be sandwiched together and clamped in a sealing relationship to provide an assembled mold-in-place gasket-forming assembly. Such clamping effectuated using bolts 110 or other fixturing devices known in the art. The assembled mold has an inlet passage, not shown, for introducing under pressure gasket forming material, which when exposed to electromagnetic radiation, cures in the mold to form a gasket which takes the shape of the selected mold. This mold-in-place gasket forming assembly and process provides a gasket that is affixed to the flange and ready to serve its purpose for its designated application. The combination of components, particularly the selection of filter 110, mold transparent to electromagnetic radiation and the gasket forming composition, allows for greatly enhanced mold cycle use without loss of acceptable gasket characteristics. Mold-in-place gaskets formed from the mold-in-place assembly of the present invention provide an acceptable gasket, after at least 100 cycles, desirably at least 500 cycles, most desirably greater 1000 cycles. More than 2000 acceptable gaskets have been produced, i.e. more than 2000 cycles were performed, while still producing acceptable gaskets. As defined above, acceptable gaskets include gaskets and molds free of defects or visible signs of degradation. The terms defects pertains to the surface of the gasket being free of mold residue and/or unwanted voids both of which may affect its sealing ability in the chosen application. The gaskets and mold-in-place of the present invention permit separation of the mold and the gasket without any visually observable mold residue or defects in the gasket being present. The selection of the filter must be chosen to permit sufficient cure of the gasket-forming composition without causing degradative effects on the mold. This is particularly important when the mold 200 is made from a polymer, such as silicone, which tends to suffer from the degradative effects of electromagnetic radiation.

In another aspect of the invention, the gasket-forming compositions of the present invention use a gasket-forming composition, which is both electromagnetic radiation curable and anaerobically curable. These compositions allow for partial cure of the gasket forming composition using electromagnetic radiation, such as UV, infrared or visible light, yet permit surface skinning so that no residue from the gasket will be left on the mold. In such instances, the gasket can then be further cured by a post-curing step using additional light, heat or being subjected to anaerobic curing conditions.

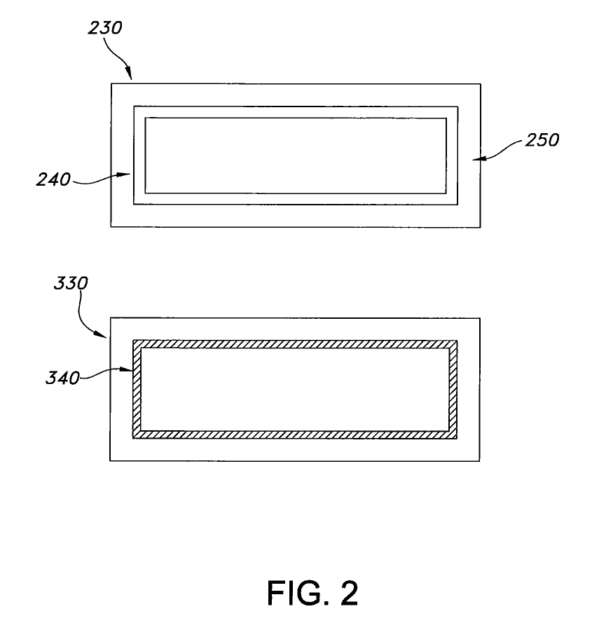

FIG. 2 shows a top view of flange 330 having a receiving area for gasket-forming material 340. Receiving area 340 may be flat or recessed to accommodate the gasket material and may be any suitable shape depending on the application. Similarly flange 330 may be representative of a part used in a variety of applications and may be any suitable size, shape or material. While many parts requiring gaskets are made from metal, particularly in the automotive, electronics and machinery markets, other materials such as ceramics, plastics, and wood may also be used as materials for flange 330. FIG. 2, also shows mold 230 having an inner surface 250 and mold cavity 240. Mold 230 is placed in mating engagement with flange 330. The perimeters of the receiving area 340 and the mold cavity 240 are coextensive when mated to provide a sealed chamber for receiving gasket-forming material during the mold-in-place injection process.

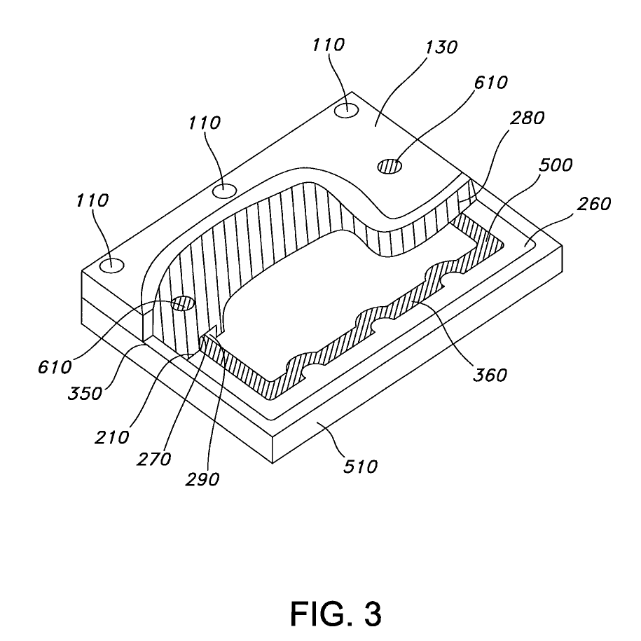

FIG. 3 represents a cutaway side profile view of the gasket-forming assembly showing a fully formed gasket made therefrom. Flange 350 shows gasket 500 injection molded onto its exterior surface receiving area 610 in the shape of mold 210. Filter 130, mold 210 and flange 350 are clamped using bolts 110 to form a sealed fixture for the injection molding process. Filter 130 and mold 210 have been cutaway to show the underlying formed gasket. Platen fixture 510 is optional and shown to provide support for the assembly. An additional fixture can be laid over filter 130 to provide support in the manufacture process. Filter 130 is laid on the outer surface of mold 210 but need only be proximal to, as opposed to touching, the surface of mold 210. Mold 210 includes an outer surface 280 and an inner surface 270 that defines mold cavity 290. Mold 260 is positioned between electromagnetic filter 130 and flange 350. The inner surface 270 of mold 260 is adjacent to flange 350. Mold cavity 290 is complementary to the area for receiving gasket-forming material 360 of flange 350. The outer surface 280 is adjacent to filter 130. Filter 130 is positioned between electromagnetic radiation source 430 and mold 260.

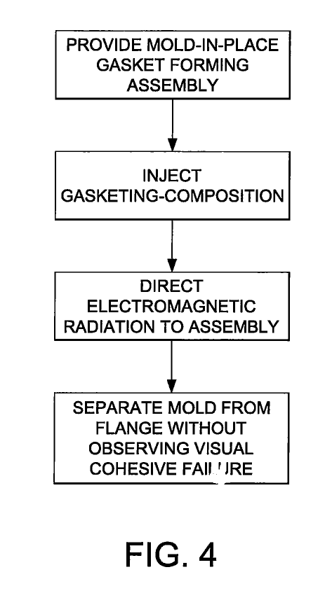

FIG. 4 shows in a flow diagram form, the first step of the invention is to provide the assembly. The second step of the mold-in-place gasketing process of the present invention is to inject a gasket-forming material into the assembly. The third step of the present invention is to direct electromagnetic radiation towards the assembly. The final step is to separate the mold from the flange without observing visual cohesive failure of either the mold or the formed gasket.

Once the composition and the injection mold are provided, the gasket-forming material may be injected into the area for receiving the gasket-forming material through the injection port to at least partially fill the cavity. The cavity may be completely filled or may be filled to any desired level. Once the composition has been injected, electromagnetic radiation may be transmitted through the electromagnetic radiation conducting means in a sufficient amount to cure the composition in the mold to form a gasket in the gasket-forming cavity. Once the composition is cured, the gasket may be removed from the cavity. The method is desirably performed at approximately room temperature, but may be performed at any desired temperatures.

In one aspect of the present invention, the step of transmitting electromagnetic radiation may be capable of varying the level of radiation during use. The amount of electromagnetic radiation transmitted through the transmissible member and onto said injected gasket-forming material may be detected and monitored. The amount of electromagnetic radiation transmitted onto the gasket-forming material may be increased when the electromagnetic radiation level declines to a preset minimum or may be decreased if the electromagnetic radiation level is too high. The mating surface of the transmissible member may be simply cleaned when the radiation level declines to the preset minimum to increase electromagnetic radiation transmittance therethrough. Alternatively, the amount of electromagnetic radiation may be controlled by providing the mating surface of the transmissible member with a first removable liner; removing the first removable liner when the radiation level declines to the preset minimum; and providing a second removable liner at the mating surface of the transmissible member to increase electromagnetic radiation transmittance therethrough.

In some aspects of the present invention, the electromagnetic radiation curable composition may be cured to form a gasket. In some embodiments, the UV curable polyacrylate may be UV cured to form a gasket. Desirably, the electromagnetic radiation curable composition is UV cured to form a gasket.

In another aspect of the present invention, the electromagnetic radiation curable composition may include a cure system and a composition selected from silicone, epoxy, polyurethane, polyester, polyether, polyamide, Polysulfide, polythioethers, polyvinylchloride, polyacrylate, acrylate, methacrylate, polymethacrylate, ethylene-acrylate elastomers, polyolefins, fluoroelastomers, fluoro-materials, hydrocarbons, styrenic & styrenic elastomers, hot-melts, reactive hot-melts, isoprene & isoprene containing elastomers, EPDM, butadiene & butadiene containing elastomers, oleoresinous compounds, acetate and combinations thereof. In some aspects, the electromagnetic radiation curable composition may include a UV curable polyacrylate.

In some aspects of the present invention, the adhesion of the formed gasket to the mold may be lower than both the cohesion of the gasket and the cohesion of the mold.

In some embodiments, the mold and filter may be held together in a fixture. In some embodiments, the flange may be held together in the fixture. Desirably, the mold, filter and fixture may be clamped together to create a pressurized seal between the flange and the mold.

In some embodiments, the mold may include a polymer that is transparent to electromagnetic radiation. Desirably, the polymer may form a three-dimension cavity. Useful polymers may include a castable or moldable elastomer. Additional useful polymers may include a heat curable casted silicone or an injected molded silicone. Desirably, the mold may include silicone.

In some embodiments, the filter may serve as a backing plate for the mold.

Desirably, the area for receiving the gasket-forming material may be flat, planar, raised, recessed or three-dimensional.

### EXAMPLES

The examples set forth below provide various samples in which different components are evaluated.

### Example 1

Table 1 below sets forth the gasket-forming material used in the present invention:

TABLE 1
Inventive Composition

| Component | % weight |
|---|---|
| Acrylate terminated telechelic | 69.5 |
| polyacrylate (1) | |
| Antioxidants (2) | 1.0 |
| N,N-dimethylacrylamide | 15.00 |
| Active fumed silica (3) | 12.75 |
| Photoinitiator (4) | 1.0 |

RC220C and RC100C available from Kaneka Corporation
Irganox B-215 available from Ciba Geigy
Aerosil R7200 available from Degusa
Irgacure 2022 available from Ciba Geigy

Table 2 below sets forth the transparent mold used in the present invention:

TABLE 2
UV Transparent Mold

| Component | % weight |
|---|---|
| Dow Corning Sylgard ™ Part A | 90.91 |
| Dow Corning Sylgard ™ Part B | 9.09 |

Table 3 below sets forth the glass ultraviolet filter used in the present invention:

TABLE 3
Glass Ultraviolet Filter
Glass UV Filter

| | |
|---|---|
| Specifications | ANSI Z97.1 2004 |
| | 16 CFR 1201 |
| | AS-2 M60 DOT 22 |
| Thickness | 5.6 mm UB |

Table 4 below shows the results of various tests performed on the gaskets made from the compositions described in Tables 1-3. As shown in Table 2, the gasket when used in conjunction with the transparent mold and UV filter (collectively referred to below as the “Inventive Assembly”) has a higher number of cycles than the gasket and transparent mold alone (Control). Thus, using a UV filter results in an increase in cycles.

TABLE 4
Test Results for Cycling Mold in Production of Gaskets

| | Inventive | |
|---|---|---|
| | Assembly | Control |
| Cycles | 1253 | 15 |
| Cycles when injection | 2000 | 30 |
| temperature was lowered to | | |
| 140 F. | | |
| Compression set 1000 Hr | 52% | 65% |
| @150 C. | | |

### Example 2

### Liquid Injection Molding Silicone

In Table 5 below, the physical properties of the gasket-forming material are shown:

TABLE 5
2 - Part Liquid Castable Molding Silicone
Uncured Properties (Liquid)

| | |
|---|---|
| Mix Ratio (weight) | 10:1 |
| Viscosity Part A (cPs) | 4600 |
| Viscosity Part B (cPs) | 60 |

Curing Conditions (Liquid to Solid)

| | |
|---|---|
| Temperature Cycle | 10 mins @ 150° C. |

Cured Properties (Solids)

| | |
|---|---|
| Durometer Hardness (Shore A) | 50 |
| Tensile Strength | 1100 |
| Elongation (%) | 120 |
| Tear Strength Die B (ppi) | 20 |

Optical Properties (Solid)

| | |
|---|---|
| Absorbance @ 400 nm Wavelength | 0.012 |
| (A) | |
| Transmission 1 cm path @ 400 nm | 97 |
| Wavelength (%) | |

In Table 6 below, the physical properties of the gasket-forming material are shown:

TABLE 6
2 - Part Liquid Castable Molding Silicone
Uncured Properties

| | |
|---|---|
| Mix Ratio (weight) | 1:1 |
| Viscosity Part A (cPs) | 440,000 |
| Viscosity Part B (cPs) | 450,000 |

Curing Conditions

| | |
|---|---|
| Temperature Cycle | 30 mins @ 177° C. |

Cured Properties (Solids)

| | |
|---|---|
| Durometer Hardness (Shore A) | 42 +/− 7 |
| Tensile Strength | 1200 |
| Elongation | 650 |

Optical Properties (Solid)

| | |
|---|---|
| Absorbance @ 400 nm Wavelength | 0.63 |
| (A) | |
| Transmission 1 cm path @ 400 nm | 23 |
| Wavelength (%) | |

In Table 7 below, the physical properties of the gasket-forming material are shown:

TABLE 7
2 - Part Liquid Injection Molding Silicone
Uncured Properties

| | |
|---|---|
| Mix Ratio (weight) | 1:1 |
| Torque, in/lbs | 27 |
| Viscosity Part A (cPs) | 440,000 |
| Viscosity Part B (cPs) | 480,000 |

Curing Conditions

| | |
|---|---|
| Temperature Cycle | 17 mins @ 177° C. |

Cured Properties (Solids)

| | |
|---|---|
| Durometer Hardness (Shore A) | 60 +/− 4 |
| Tensile Strength | 1360 |
| Elongation | 470 |
| Tear Strength Die B (ppi) | 230 |

Optical Properties (Solid)

| | |
|---|---|
| Absorbance @ 400 nm Wavelength | 0.74 |
| (A) | |
| Transmission 1 cm path @ 400 nm | 18 |
| Wavelength (%) | |

In Table 8 below, the physical properties of the gasket-forming material are shown:

TABLE 8
2 - Part Liquid Injection Molding Silicone
Uncured Properties

| | |
|---|---|
| Mix Ratio (weight) | 1:1 |
| Torque, in/lbs | 27 |
| Viscosity Part A (cPs) | 440,000 |
| Viscosity Part B (cPs) | 480,000 |

Curing Conditions

| | |
|---|---|
| Temperature Cycle | 17 mins @ 177° C. |

Cured Properties (Solids)

| | |
|---|---|
| Durometer Hardness (Shore A) | 60 +/− 4 |
| Tensile Strength | 1360 |
| Elongation | 470 |
| Tear Strength Die B (ppi) | 230 |

Optical Properties (Solid)

| | |
|---|---|
| Absorbance @ 400 nm Wavelength | 0.74 |
| (A) | |
| Transmission 1 cm path @ 400 nm | 18 |
| Wavelength (%) | |

### Example 3

A mold-in-place gasket-forming assembly was made in accordance with the present invention. First, a mold assembly was provided. The mold assembly included a flange with an area for receiving a gasket-forming material, a mold transparent to ultraviolet radiation and an ultraviolet radiation filter. Second, a gasket-forming material was injected into the area for receiving the gasket-forming material. The assembly was positioned near an ultraviolet radiation source. Then, ultraviolet radiation was directed through the ultraviolet radiation filter and mold to cure the gasket-forming material. A gasket was then formed. Finally, the gasket was separated from the mold without visually detectable cohesive failure of the gasket or the mold. This entire process was repeated 1253 times without experiencing a failure.

### Example 4

The process described in Example 3 was repeated. However, the injection temperature was lowered to 140° F. Lowering the injection temperature to this level increased the number of cycles to 2000 times before experiencing a failure.

What is claimed is:

1. A mold-in-place gasket-forming assembly comprising:
(i) a flange having an area for receiving flowable gasket-forming material;
(ii) a mold transparent to electromagnetic radiation and having inner and outer surfaces, said inner surface defining a mold cavity, said mold being sealed about said area to receive gasket-forming material directed therein;
(iii) an electromagnetic radiation filter positioned between a source of electromagnetic radiation and said mold cavity, wherein said electromagnetic radiation filter is proximal to said outer surface of said mold to filter and/or attenuate wavelengths of light below 10,000 nm; and
(iv) a gasket-forming material comprising an electromagnetic radiation curable composition.

2. The assembly of claim 1, wherein the electromagnetic radiation curable composition is cured to form a gasket.

3. The assembly of claim 1, wherein said filter filters and/or attenuates wavelengths of light below 750 nm.

4. The assembly of claim 1, wherein said filter filters and/or attenuates wavelengths of light below 400 nm.

5. The assembly of claim 1, wherein the electromagnetic radiation curable composition comprises a cure system and a polyacrylate

6. The assembly of claim 1, wherein the electromagnetic radiation curable composition comprises a cure system and a silicone.

7. The assembly of claim 1, wherein the electromagnetic radiation curable composition comprises a cure system and an epoxy, polyurethane, polyester, polyether, polyamide, polysulfide, polythioethers, polyvinylchloride, acrylate, methacrylate, polymethacrylate, ethylene-acrylate elastomers, polyolefins, fluoroelastomers, fluoro-materials, hydrocarbons, styrenic & styrenic elastomers, hot-melts, reactive hot-melts, isoprene & isoprene containing elastomers, EPDM, butadiene & butadiene containing elastomers, oleoresinous compounds, an acetate and combinations thereof.

8. The assembly of claim 1, wherein the adhesion of the formed gasket to said mold remains lower than both the cohesion of said gasket and the cohesion of the said mold.

9. The assembly of claim 1, wherein said mold, filter and flange are held together in a fixture.

10. The assembly of claim 9, wherein said fixture is clamped together to create a pressurized seal between said flange and said mold.

11. The assembly of claim 1, wherein said mold comprises a heat curable casted or injected molded silicone.

12. The assembly of claim 1, wherein the filter serves as a backing plate for said mold.

13. The assembly of claim 1, wherein said area is flat, planar, raised, recessed or three-dimensional.

14. The assembly of claim 1, wherein said mold comprises silicone.

15. The assembly of claim 1, wherein said filter is selected from the group consisting of UV filters, visible filters, infrared filters and combinations thereof.

16. A mold-in-place gasket-forming assembly comprising:
(i) an application flange having a recessed area for receiving injected gasket-forming material;
(ii) a silicone mold transparent to UV light and having inner and outer surfaces, said inner surface defining a mold cavity, said silicone mold being sealed about said recessed area to receive gasket-forming material injected therein;
(iii) a UV filter positioned proximal to said outer surface of said silicone mold to filter out wavelengths lower than 400 mm; and
(iv) a gasket-forming material comprising a UV curable polyacrylate.

17. The assembly of claim 16, wherein the UV curable polyacrylate is UV cured to form a gasket.

18. The assembly of claim 16, wherein the formed gasket has lower interfacial adhesion than the cohesive strength of the gasket or mold to facilitate repeated removals of said mold.

19. A mold-in-place gasketing process comprising:
a) providing a mold assembly comprising:
(i) a flange having an area for receiving a flowable gasket-forming material;
(ii) a mold transparent to electromagnetic radiation and having inner and outer surfaces, said inner surface defining a mold cavity, said mold being sealed about said area to receive gasket-forming material directed therein; and
(iii) an electromagnetic radiation filter positioned proximal to said outer surface of said mold to filter or attenuate wavelengths of light below 10,000 nm;
b) injecting a gasket-forming material comprising an electromagnetic radiation curable composition into said area for receiving flowable gasket-forming material of said mold assembly;
c) directing electromagnetic radiation through said filter and mold to cure said gasket-forming material and form a gasket; and
d) separating said gasket from said mold without visually detectable cohesive failure of said gasket or said mold.

20. The process of claim 19, further comprising post curing said surface of said gasket.

21. The process of claim 19, wherein said area is flat, planar, raised, recessed or three-dimensional.

22. The process of claim 19, wherein said mold comprises silicone.

23. The process of claim 19, wherein said filter filters wavelengths of light below 750 nm.

24. The process of claim 19, wherein said filter filters wavelengths of light below 400 nm.

25. The process of claim 19, wherein the mold is cycled at least 500 times without visually observable defects.

26. The process of claim 19, wherein the mold is cycled at least 1200 times without visually observable defects.

27. The process of claim 19, wherein the mold is cycled up to 5000 cycles without visually observable defects.

28. The process of claim 19, wherein the injection temperature is below 420° F.

29. The process of claim 19, wherein the interfacial adhesion of said gasket to said mold is less than the cohesive strength of said gasket and said mold.
